(19) United States
(12) Patent Application Publication
(10) Pub. No.: US 2012/0200503 A1
(43) Pub. Date: Aug. 9, 2012

(54) SIZEABLE VIRTUAL KEYBOARD FOR PORTABLE COMPUTING DEVICES

(76) Inventor: Georges BERENGER, Menlo Park, CA (US)

(21) Appl. No.: 13/171,075

(22) Filed: Jun. 28, 2011

Related U.S. Application Data
(60) Provisional application No. 61/440,381, filed on Feb. 7, 2011.

(51) Int. Cl. G06F 3/02

(52) U.S. Cl. 345/168

(57) ABSTRACT

Disclosed herein is a method and device for generating and resizing virtual keyboard comprising detecting an input for a size of a virtual keyboard and presenting the virtual keyboard at the desired size on a display surface.

### RELATED APPLICATIONS

This application claims the benefit of priority under 35 U.S.C. 119(e) to Provisional Application Ser. No. 61/440,381, filed Feb. 7, 2011, titled SIZEABLE VIRTUAL KEYBOARD FOR PORTABLE COMPUTING DEVICES, which is incorporated herein by reference in its entirety.

### TECHNICAL FIELD

The disclosed embodiments relate to the field of virtual keyboards for electronic devices.

### BACKGROUND

Computing devices, particularly portable computing devices and other small form-factor computing devices, often require a keyboard for inputting characters into one or more text fields or other input areas that are displayed on the device. Some of these portable computing devices have keyboards on the face of the device while others have keyboards that slide in and out from the computing device.

In other portable computing devices, particularly those with touch sensitive displays, virtual keyboards are rendered directly on the display. When a user actuates a portion of the touch sensitive display that corresponds to a character key of the virtual keyboard, the character is output on the display. However, one drawback to currently available virtual keyboards is that the size of the virtual keyboard and corresponding character keys is static. Therefore, a user may not be able to adjust the size of the virtual keyboard according to the user's preference.

### BRIEF DESCRIPTION OF THE DRAWINGS

FIG. 1 illustrates a sizable virtual keyboard interface for a computing device, according to one or more embodiments.

FIGS. 2A-2D illustrate a resizable virtual keyboard according to one or more embodiments;

FIG. 2E and FIG. 2F illustrates a variation to embodiments such as described by including graphic features with the virtual keyboard in order to facilitate size selection by the user;

FIG. 3A is a flow chart illustrating a method for resizing a virtual keyboard according to one or more embodiments;

FIG. 3B is a flow chart illustrating a method for providing additional virtual character keys on a virtual keyboard according to one or more embodiments;

FIGS. 4A-4B illustrate a virtual keyboard having additional virtual character keys according to one or more embodiments;

FIG. 5 illustrates is virtual keyboard having a plurality of hit regions according to one or more embodiments;

FIGS. 6A-6B illustrate virtual keyboards having a various virtual character key configurations according to one or more embodiments; and

FIG. 7 illustrates a hardware diagram for a portable computing device that is configured to support any of the embodiments described herein.

### DETAILED DESCRIPTION

Embodiments described herein disclose a system and method for resizing a virtual keyboard of a computing device. According to an embodiment, the virtual keyboard may be sized or resized based on user input, such as, for example, selecting a preset size from a plurality of preset sizes. Once the user has selected the desired size, the virtual keyboard is rendered on the display in the desired size.

In another embodiment, the virtual keyboard may be manually resized by a user. In such embodiments, the user may manually resize the virtual keyboard using a dragging motion on a touch sensitive display of a device on which the virtual keyboard has been rendered. The size of the virtual keyboard is determined based on the dragging motion and the virtual keyboard is output on a display in the desired size.

In another embodiment, the virtual keyboard may be configured to display a plurality of rows, with each row having a plurality of virtual character keys. In certain embodiments, additional virtual character keys may be output on the display based on user input. The user input may correspond to a user long-pressing one or more virtual character keys. In such embodiments, the additional virtual character keys may include characters having accent marks that are not typically displayed on standard QWERTY keyboards. In addition to displaying the additional characters, one or more of the additional characters and corresponding virtual character keys may be capitalized when a user actuates a secondary virtual character key.

Still further, the virtual keyboard may include one or more hit regions that correspond to the one or more virtual character keys. Thus, as the virtual keyboard and the corresponding virtual character keys are sized or resized, the hit regions corresponding to each of the virtual character keys are sized or resized accordingly.

As used herein, the term “virtual” means “computer-generated”, such as on a display surface or other interactive medium.

Additionally, the term “resize”, “size” or variations thereof, in the context of “virtual keyboard” means altering a size of one dimension of the virtual keyboard relative to another dimension.

As used herein, the terms “programmatic”, “programmatically” or variations thereof mean through execution of code, programming or other logic. A programmatic action may be performed with software, firmware or hardware, and generally without user-intervention, albeit not necessarily automatically, as the action may be manually triggered.

One or more embodiments described herein may be implemented using programmatic elements, often referred to as modules or components, although other names may be used. Such programmatic elements may include a program, a subroutine, a portion of a program, or a software component or a hardware component capable of performing one or more stated tasks or functions. As used herein, a module or component, can exist on a hardware component independently of other modules/components or a module/component can be a shared element or process of other modules/components, programs or machines. A module or component may reside on one machine, such as on a client or on a server, or may alternatively be distributed amongst multiple machines, such as on multiple clients or server machines. Any system described may be implemented in whole or in part on a server, or as part of a network service. Alternatively, a system such as described herein may be implemented on a local computer or terminal, in whole or in part. In either case, implementation of system provided for in this application may require use of memory, processors and network resources (including data ports, and signal lines (optical, electrical etc.), unless stated otherwise.

Furthermore, one or more embodiments described herein may be implemented through the use of instructions that are executable by one or more processors. These instructions may be carried on a computer-readable medium. Machines shown in figures below provide examples of processing resources and computer-readable mediums on which instructions for implementing one or more embodiments can be carried and/or executed. In particular, the numerous machines shown with one or more embodiments include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and personal digital assistants (PDAs)), and magnetic memory. Computers, terminals, network enabled devices (e.g. portable devices such as cell phones) are all examples of machines and devices that utilize processors, memory, and instructions stored on computer-readable mediums.

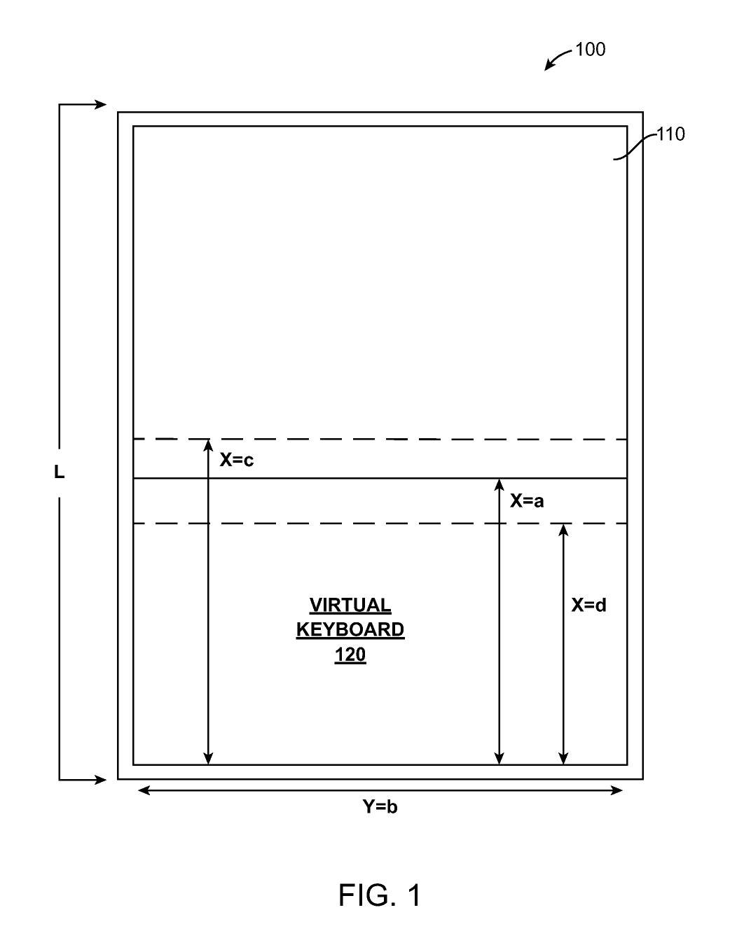

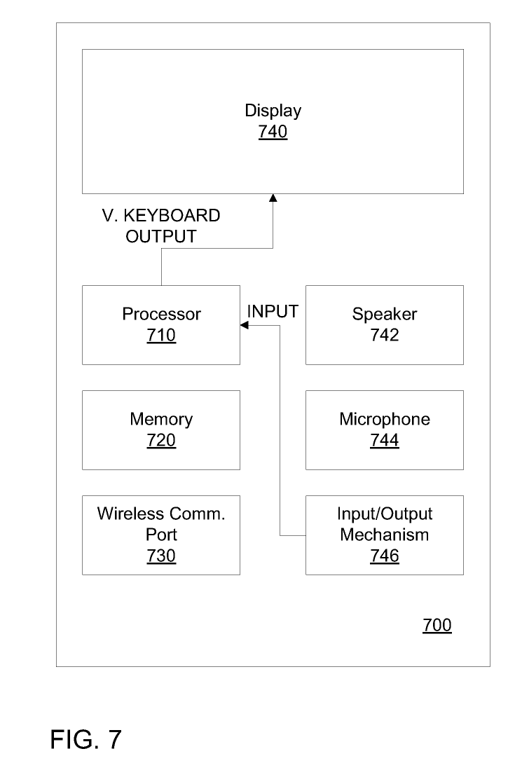

FIG. 1 illustrates a sizable virtual keyboard interface for a computing device, according to one or more embodiments. A computing device such as shown may include hardware assembly such as shown by an embodiment of FIG. 7. With reference to FIG. 1, a display surface 110 of a computing device 100 may be responsive to touch by a finger or object. A processor of the computing device 100 is configured to present a virtual keyboard 120 (i) according to a size that is selected by user input, and/or (ii) resized once displayed based on input from the user. In particular, dimensions of the virtual keyboard 120 can be provided by height (x) and width (y), where height is the progression of the virtual keyboard 120 in one direction of the display surface 110 (e.g. along length direction L of display surface 110 when the device 100 is in portrait orientation), and width is the space occupied by the keyboard in its span of keys (e.g. from Q to P in QWERTY layout).

According to an example shown by FIG. 1, in a first size orientation, virtual keyboard 120 is presented by the processor to have dimensions of (x=a) and (y=b). With user input, the virtual keyboard 120 is presented to have dimensions of (x=c) and (y=b). In altering the height dimension between (x=a) and (x=c) (enlargement), embodiments described herein vary (i) key dimensions, (ii) spacing between keys, and/or (iii) layout. Similar considerations may be made for varying the height dimension between (x=a) and (x=d) (reduction).

According to some embodiments, the display surface 110 can be drawn in portrait or landscape orientations. The virtual keyboard 120 may be presented in either direction, stretched or otherwise dimensioned to occupy a designated portion of the overall display screen in either orientation. The virtual keyboard 120 may be sizable in either portrait or landscape orientations.

In variations, the virtual keyboard 120 is sizable or resizable in a particular orientation, in response to other than user input. For example, the virtual keyboard 120 may be sizable/resizable based on events such as sensor input (e.g. proximity of skin or contact), application events (e.g. application launch) or mode settings.

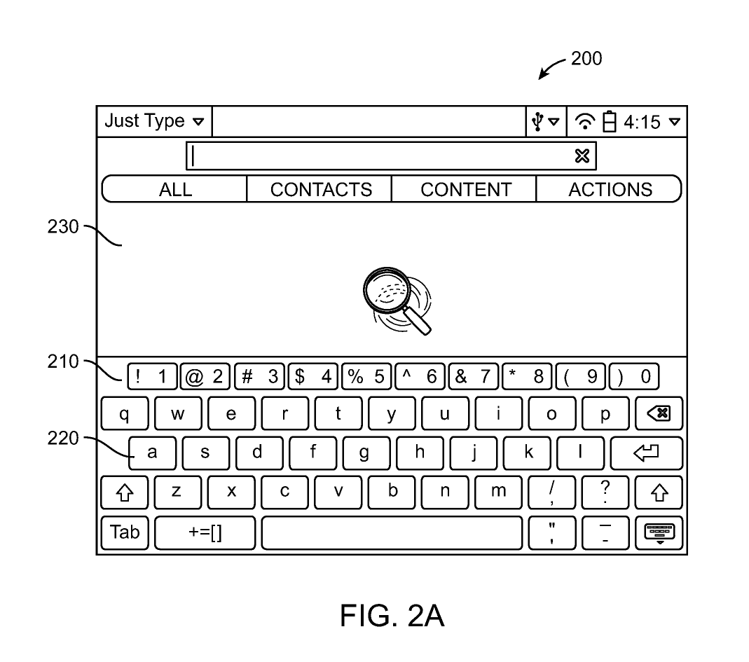

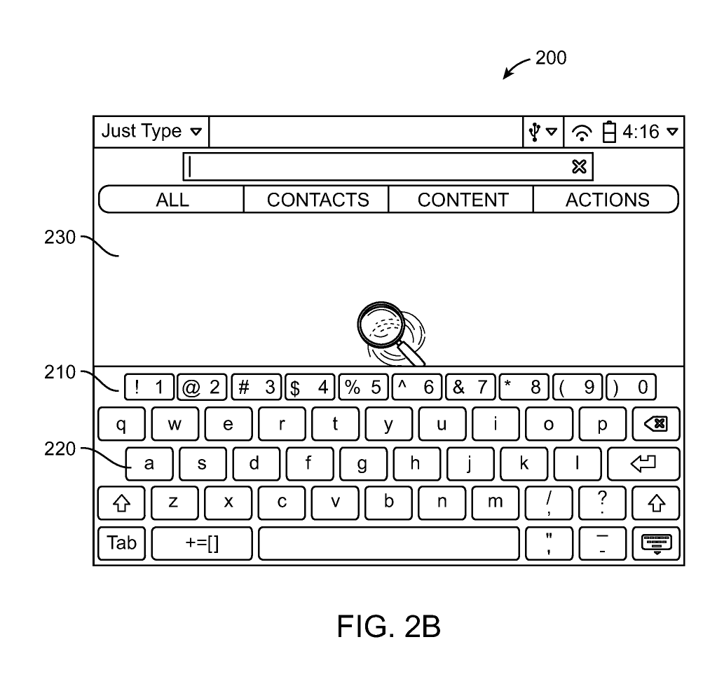

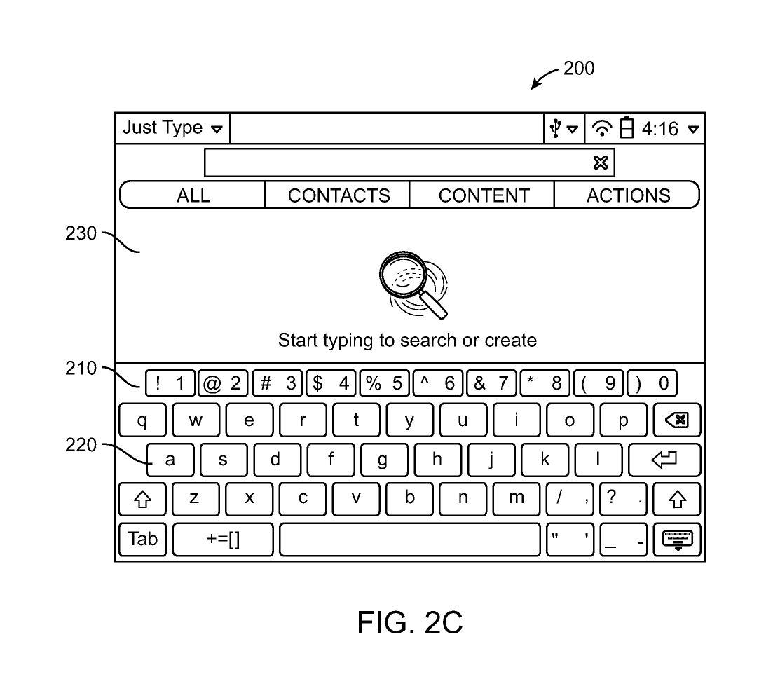

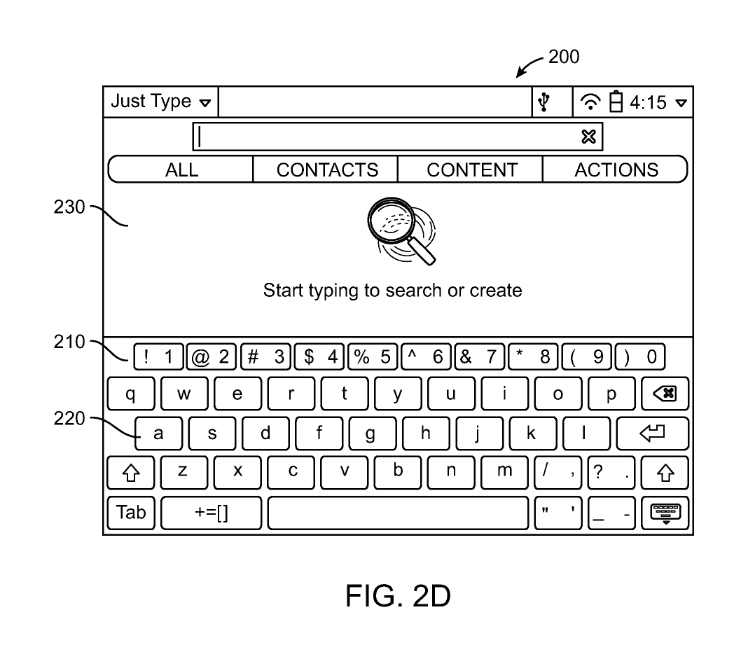

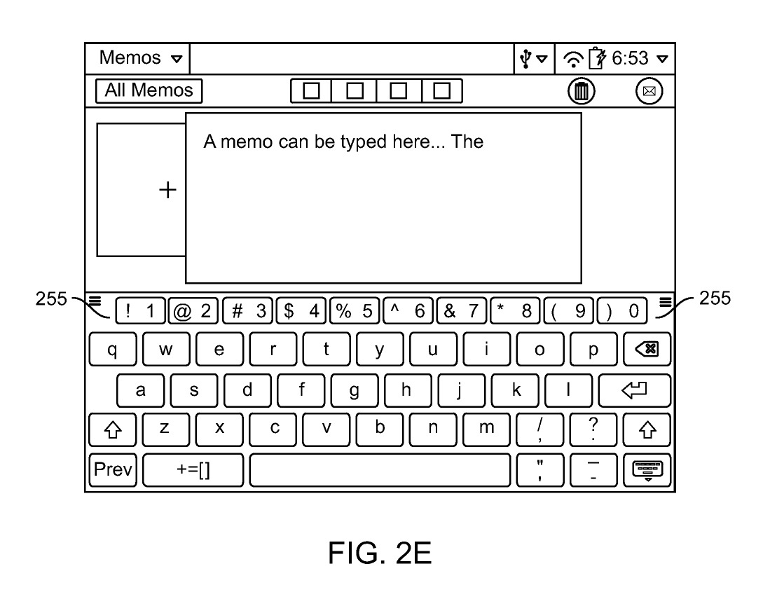

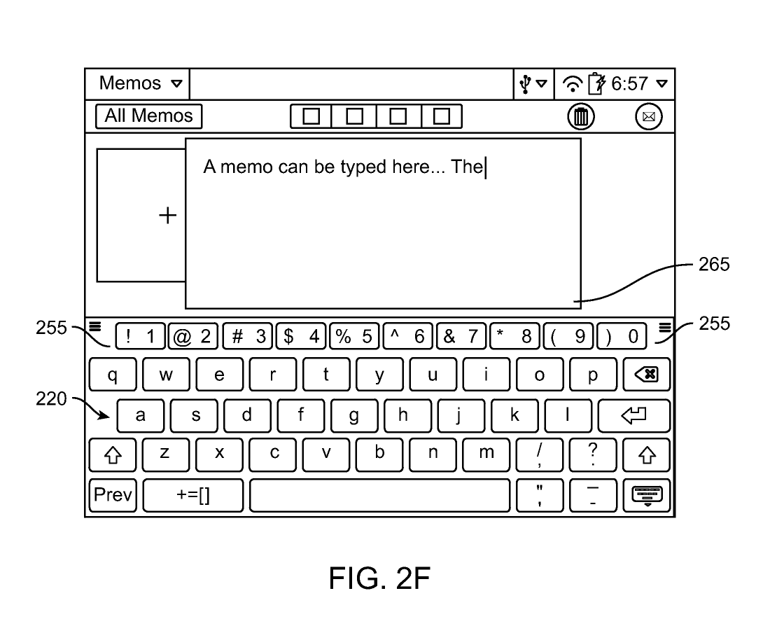

FIGS. 2A-2D illustrate a virtual keyboard 200 interface for a computing device that is sizeable by user-input, according to embodiments. The virtual keyboard 200 can be presented on interactive displays, such as on a display of a computing device (e.g. touch screen of tablet or mobile computing device).

As will be discussed in greater detail below, the virtual keyboard 200 may be sized or resized based on user input. The user input may correspond to a user selecting a preset size from a plurality of sizes. Alternatively, a user may manually adjust the size of the virtual keyboard 200 when displayed using a dragging motion or other gesture on or near the touch sensitive display.

As shown in each of FIGS. 2A-2D, the virtual keyboard 200 includes a plurality of rows 210, with each of the plurality of rows 210 having a plurality of virtual character keys 220. In certain embodiments, the virtual keyboard 200 has five rows of virtual character keys 220 with the virtual character keys being arranged in a QWERTY configuration. A first row of the plurality of rows 210 may include virtual character keys 220 corresponding to the numbers 1-0 while the remaining rows include virtual character keys 220 corresponding to letters of the alphabet. Additional virtual character keys 220 referred to herein as secondary keys may also be included in each of the plurality of rows 210. Exemplary secondary keys include virtual keys such as a space bar key, a shift key, a return key, a delete or backspace key, a tab key etc.

Although the virtual keyboard 200 is shown in each of FIGS. 2A-2D with five rows, it is contemplated that the virtual keyboard 200 may have fewer rows. For example, it is contemplated that the virtual keyboard 200 may display four rows of virtual character keys 220 with the number row being omitted. As such, a user may be presented with one or more options as to how many of the plurality of rows 110, and which rows of the plurality of rows 110, are displayed.

Alternatively, one or more of the plurality of rows 110 of the virtual keyboard 200 may be selectively hidden and revealed to a user based on user preference. For example, the row containing the virtual character keys 220 corresponding to the numbers from 1-0 may be hidden until a user performs a particular stroke or motion on the touch sensitive display or actuates a particular virtual character key 220. In response to the particular stroke or motion or in response to the actuation of a particular key, the hidden row is displayed. When the hidden row is displayed in response to the motion, the hidden row may remain visible until the user performs an action to once again hide the displayed row.

In certain embodiments, the virtual keyboard 200 may be resized by a user when the virtual keyboard is output on a display of the device regardless of the orientation of the device. For example, the user may resize the virtual keyboard 200 when the device is in a landscape orientation or a portrait orientation. In another embodiment, the virtual keyboard 200 may be sized when the virtual keyboard 200 is hidden from view.

Regardless of the orientation of the device and whether the virtual keyboard is displayed, a user may size or resize the virtual keyboard 200 by selecting one preset size from a plurality of preset sizes. For example, the user may be presented a plurality of preset sizes. The preset sizes may include sizes that range from extra small to large. For example, FIG. 2A shows a virtual keyboard 200 in a “Regular” preset size, FIG. 2B shows the virtual keyboard 200 in a “Large” preset size, FIG. 2C shows the virtual keyboard 200 in a “Small” preset size, and FIG. 2D shows the virtual keyboard in an “Extra Small” preset size.

Certain embodiments provide that the user may manually resize the virtual keyboard 200 when the virtual keyboard 200 has been rendered on a display of the device. The manual resizing of the virtual keyboard is accomplished by a user touching a virtual handle or other icon on the virtual keyboard 200 and dragging the virtual handle or icon in a particular direction. Based on the direction of the dragging motion, the size virtual keyboard 200 is either enlarged or reduced. Once the desired size has been achieved, the user releases the virtual handle or icon and the virtual keyboard 200 remains at the desired size.

As briefly discussed above, the virtual keyboard 200 may be sized when the virtual keyboard 200 is hidden from view. In such instances, a user may access an options menu and may be provided a list of preset sizes. As described above, the preset sizes may include one or more sizes in the range from extra-small to large. In another embodiment, a user may input a desired size based on the number of pixels of the virtual keyboard 200, a desired viewable area of the display, and other such parameters. Thus, when the virtual keyboard 200 is subsequently rendered on the display, the virtual keyboard 200 will be rendered in the user selected size.

Referring back to FIGS. 2A-2D, when the virtual keyboard 200 is output on a display, a viewable area 230 of the display is dependent on the size of the virtual keyboard 200. As used herein, the viewable area 230 of the display is an area in which graphics, text content, or other forms of media are output on the display to be viewed by a user. As shown in each of FIGS. 2A-2D, as the virtual keyboard 200 increases in size on the display, the viewable area 230 of the display decreases in size.

For example, when comparing the “Regular” size of the virtual keyboard 200 of FIG. 2A to the “Large” size of virtual keyboard 200 of FIG. 2B, it is shown that the virtual keyboard 200 of FIG. 2B requires more display space than the virtual keyboard 200 of FIG. 2A. As a result, the viewable area 230 of the display of FIG. 2B is smaller than the viewable area 230 of the display shown in FIG. 2A. Additionally, when comparing either the “Small” size virtual keyboard 200 of FIG. 2C and the “Extra Small” size virtual keyboard 200 of FIG. 2D to the “Regular” size virtual keyboard 200 of FIG. 2A or the “Large” size virtual keyboard 200 of FIG. 2B, both the “Small” size virtual keyboard 200 of FIG. 2C and the “Extra Small” size virtual keyboard 200 of FIG. 2D require less area of the display. Thus, the viewable area 230 of the display shown in FIG. 2C and the viewable area 230 of the display shown in FIG. 2D are both larger than the viewable areas 230 shown in FIG. 2A and FIG. 2B.

As the virtual keyboard 200 increases or decreases in size, each of the plurality of virtual character keys 220 of the virtual keyboard 200 also increase and decrease in size. Referring back to each of FIGS. 2A-2D, it is shown that the virtual character keys 220 of the “Regular” size virtual keyboard 200 of FIG. 2A are smaller than the virtual character keys 220 of the “Large” size virtual keyboard 200 of FIG. 2B. Additionally, it can be seen that the virtual character keys 220 of the “Small” size virtual keyboard 200 of FIG. 2C and the virtual character keys 220 of the “Extra Small” size virtual keyboard 200 of FIG. 2D are smaller than the virtual character keys 220 of FIG. 2A and FIG. 2B.

To reduce the size of each of the virtual character keys 220, one or more pixels may be removed from at least one of the outer edges of each of the virtual character keys 220. Conversely, when the size of each of the virtual character keys 220 is enlarged, one or more pixels may be added to at least one of the outer edges of each of the virtual character keys 220.

For example, when the virtual character keys 220 are sized or resized, the width of each of the virtual character keys 220 may remain constant while the height of the each of the virtual character keys 220 is scaled accordingly. Alternatively, both the height and width of each of the plurality of character keys 220 may be scaled based on the overall size change of the virtual keyboard. Thus, if the virtual keyboard is resized from “Large” to “Extra Small”, pixels from all sides of each of the virtual character keys 220 are removed (e.g., both the width and height of the virtual character keys 220 are reduced).

In certain embodiments, each of the virtual character keys 220 of the virtual keyboard 200 may be scaled from a first size to a second size when the device on which the virtual keyboard 200 is displayed is moved from a landscape orientation to a portrait orientation and vice versa. However, although each of the virtual character keys are scaled based on an orientation of the device, the scaled virtual character keys 220 are equivalent to the non-scaled virtual character keys 220 of the previous orientation. For example, if the device on which the virtual keyboard is rendered is in a landscape orientation, and the user has selected a “Large” sized virtual keyboard 200, each of the virtual character keys 220 may have a width of x and a height of y. When the device on which the virtual keyboard 200 is rendered is moved from the landscape orientation to a portrait orientation, the size of each of the virtual character keys 220 may be scaled such that each of the virtual character keys 220 now has a width of x′ and a height of y′ where 1) x′ is less than x and y′ is less than y, and 2) the width x′ and the height y′ are equivalent to the “Large” preset size of the virtual keyboard 200 when the device is in the portrait orientation.

In another embodiment, a user may configure one or more settings of the device such that the virtual keyboard 200 is displayed in a first size (e.g., Extra-Small) when in a first orientation and a second size (e.g., Large) when the device is in a second orientation. For example, a user may want the virtual keyboard 200 to be rendered in the “Extra Small” preset size when the device is in a landscape orientation and the “Large” preset size when the devices is in the landscape orientation.

In certain embodiments, as the size of each of the virtual character keys 220 of the virtual keyboard 200 increase or decrease, the spacing or thickness of a region between each of the virtual characters keys 220 may also increase or decrease. For example, if the user has selected a “Small” size virtual keyboard 200, such as shown in FIG. 2C, the space between each of the virtual character keys 220 may be larger than the space between each of the virtual character keys 220 in the “Regular” size virtual keyboard 200 shown in FIG. 2A. Thus, although the virtual character keys 220 of the “Small” size virtual keyboard 200 are smaller in size than the virtual character keys 220 of the “Regular” sized virtual keyboard 200, the extra spacing between the virtual character keys 220 of the “Small” size virtual keyboard 200 may help prevent a user from actuating an incorrect key or a neighboring key when a particular virtual character key 220 is actuated.

For example, if the user has selected a “Small” size virtual keyboard 200 and actuates a virtual character key 220 corresponding to the character “s”, the extra spacing between each of the virtual character keys 220 may prevent a user from accidentally or unintentionally hitting a virtual character key 220 corresponding to the neighboring “d”, “e”, “w”, “a”, “z”, or “x” virtual character keys.

FIG. 2E and FIG. 2F illustrates a variation to embodiments such as described by including graphic features with the virtual keyboard in order to facilitate size selection by the user. Specifically, virtual keyboard 200 includes handles 255, 255 which facilitate size selection by the user. In one implementation, the handles 255 can be positioned at opposing locations, near the resize boundary 265 of the keypad 220. The user can interact with the handles 255 to resize the keyboard. Additionally, in some implementations, the resize boundary 265 may illuminate to notify the user of the resize position indicated by the handles 255, before the user selects to resize (e.g. while the user's finger remains in contact with the handles 255). The boundary line 265 can move, for example, to alternative positions, based on the user's positioning of the handles 255 (see FIG. 2F).

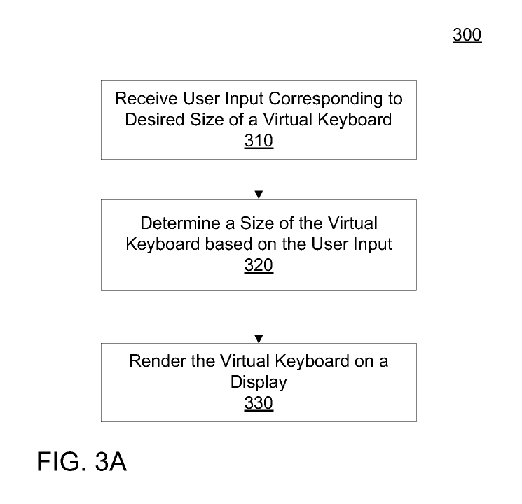

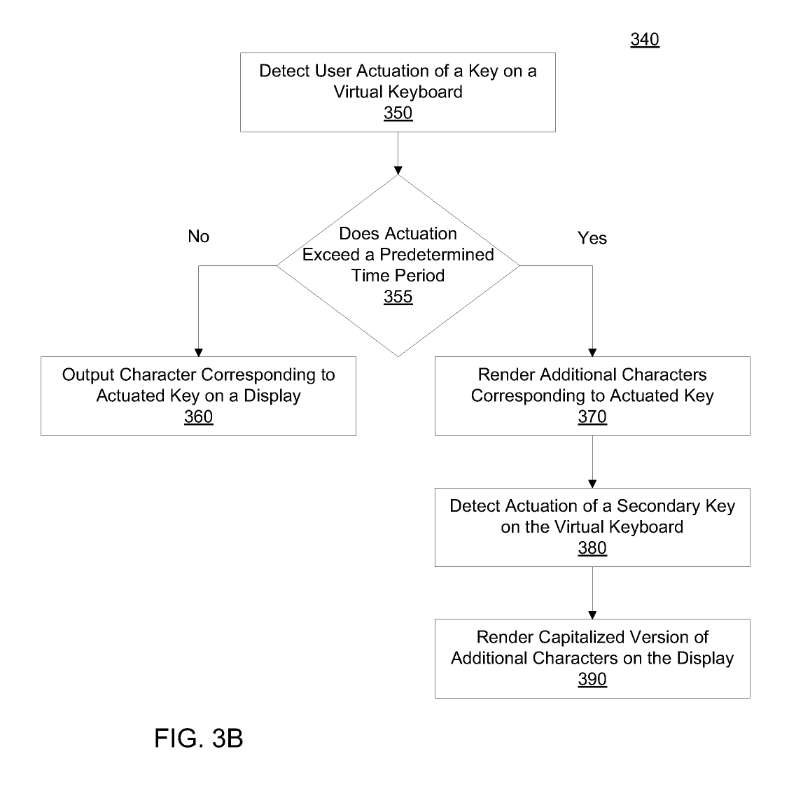

FIG. 3A is a flow chart illustrating a method 300 for resizing a virtual keyboard according to one or more embodiments. In certain embodiments, the method 300 may be used to size or resize each of the virtual keyboards 200 shown and described above with respect to FIGS. 2A-2D. Additionally, the method 300 described herein may be performed regardless of whether the virtual keyboard 200 is rendered on the display or hidden from view.

The method 300 for resizing the virtual keyboard 200 begins when user input corresponding to a desired size of the virtual keyboard is received 310. In certain embodiments, the user input may correspond to a selection of a desired size from a plurality of preset sizes. The preset sizes may include a “Regular” size, such as shown in FIG. 2A; a “Large” size, such as shown in FIG. 2B; a “Small” size, such as shown in FIG. 2C; and an “Extra Small” size, such as shown in FIG. 2D.

In another embodiment, a user may be able to manually resize the virtual keyboard 200 by selecting an icon or a virtual handle of the virtual keyboard 200 and dragging the icon or handle to a particular position on the display. As the user drags the virtual handle, the size of the virtual keyboard 200 increases or decreases. When the user has enlarged or reduced the virtual keyboard 200 to the desired size, the user may release the virtual handle and the virtual keyboard 200 is resized based on the user input.

Although a virtual handle or icon is specifically mentioned, it is contemplated that other gestures or actions may be made by the user on the touch sensitive display to indicate that the user wishes to resize the virtual keyboard 200. Such gestures may include placing one or more fingers on an area of the touch sensitive display and performing a particular motion, such as, for example, moving two fingers apart or closer together.

In another embodiment, the user input may correspond to a user dragging an icon or a virtual handle associated with the virtual keyboard 200 from a first range to a second range, where the first range corresponds to a first preset size and where the second range corresponds to a second preset size. For example, if the current size of the virtual keyboard 200 was set to a “Small” size, and the user drags the virtual handle or icon of the virtual keyboard 200 in a manner consistent with reducing the size of the virtual keyboard 200, the size of the virtual keyboard 200 is reduced from the preset “Small” size shown in FIG. 2C to the preset “Extra Small” size shown in FIG. 2D. Alternatively, if the current size of the virtual keyboard 200 was set to a “Small” size and the user drags the virtual handle or icon of the virtual keyboard 200 in a manner consistent with increasing the size of the virtual keyboard 200, the size of the virtual keyboard 200 increases from the “Small” size to the “Regular” size shown FIG. 2A.

In yet another embodiment, each of the preset sizes (e.g., Regular, Large, Small, and Extra Small) may have an associated range. Thus, when the user manually resizes the virtual keyboard 200, and the size of the virtual keyboard 200 falls within the range associated with one of the preset sizes, the virtual keyboard 200 is resized accordingly. Therefore, a user may manually resize the virtual keyboard 200 from, for example, the “Extra Small” size to the “Large” size in a single motion.

For example, the “Large” preset size may be associated with a first range (e.g., 60% or more of the viewable area), the “Regular” preset size may be associated with a second range (e.g., between 50% and 60% of the viewable area), the “Small” preset size may be associated with a third range (e.g., between 40% and 50% of the viewable area) and the “Extra Small” preset size may be associated with a fourth range (e.g., less than 40% of the viewable area). If the user is manually resizing the virtual keyboard 200 using a virtual handle or icon and resizes the virtual keyboard 200 to size such that the virtual keyboard 200 occupies 45% of the viewable area 230 (FIG. 2A) of the display, the virtual keyboard 200 will be rendered in the “Small” size. Similarly, if the user manually resizes the virtual keyboard 200 such that 55% of the viewable area 230 of the display is occupied by the virtual keyboard 200, the virtual keyboard 200 will be rendered in the “Regular” size.

Once the user input has been received, the size of the virtual keyboard 200 is determined based on the user input 320. In certain embodiments, this determining step may include determining which of the preset sizes (e.g., “Regular”, “Large”, “Small”, or “Extra Small”) should be used when rendering the virtual keyboard 200 on the display after the user has manually resized the virtual keyboard such as discussed above. Additionally, the size of a graphical area of each virtual character keys 220 (FIG. 2A), including the spacing between each virtual character key 220 is also determined. Thus, based on the determined size of the virtual keyboard 200, one or more pixels may need to be added or removed from each of the virtual character keys 220.

As will be discussed in greater detail below, each of the virtual character keys 220 also has a corresponding hit region. Thus, as the size of the virtual keyboard 200 and virtual character keys 220 increases or decreases, the hit region corresponding to each of the virtual character keys 220 may also increase or decrease. When the user input has been received and the size of the virtual keyboard 200 has been determined, the virtual keyboard 200, in the selected size, is output on the display 330 of the device.

In certain embodiments, the size of the virtual keyboard 200 may also be determined based on the content that is displayed. For example, if a user is viewing content on the display that includes one or more editable text fields, the virtual keyboard 200 may be automatically sized such that most, if not all of the editable text fields are viewable on the display.

FIG. 3B is a flow chart illustrating a method 340 for providing additional characters on a virtual keyboard according to one or more embodiments. The method 340 for providing additional characters on a virtual keyboard begins when user actuation of virtual character key, such as, for example, virtual character key 220 (FIG. 2A) is detected 350. In certain embodiments, at least one of the virtual character keys 220 may include markings to indicate that additional virtual character keys with corresponding characters are available for a particular virtual character key 220.

Examples of additional characters include characters that have accent marks that are used in foreign languages, such as, for example, characters in French, Spanish, Italian, Polish, Portuguese, etc. For example, additional characters that may be available for the standard English character “e” may include “\tilde{e}” “è” “ë” “ê” “é” and “è”. Although specific examples of languages and corresponding characters have been given, it is contemplated that additional characters for any number of languages may be available for a given English equivalent character.

When user actuation of a virtual character key 220 has been detected, a determination is made as to whether the actuation of the virtual character key 220 exceeds a predetermined time period 355. In certain embodiments, the predetermined time period may be one second or longer, two seconds or longer, or three seconds or longer. In another embodiment, the predetermined time period may be set by a user.

If the user actuation of the virtual character key 220 does not exceed the predetermined time period (e.g., the user touches and releases the virtual character key without performing a long-press), the character corresponding to the actuated virtual character key 220 is output on a portion of the display 360, such as, for example, the viewable area 230 (FIG. 2A) of the display.

If however, it is determined that the user has actuated the virtual character key 220 for the predetermined time period (e.g., the user performs a long-press of the virtual character key 220), additional virtual character keys corresponding to the actuated virtual character key 220 are rendered on the display 370.

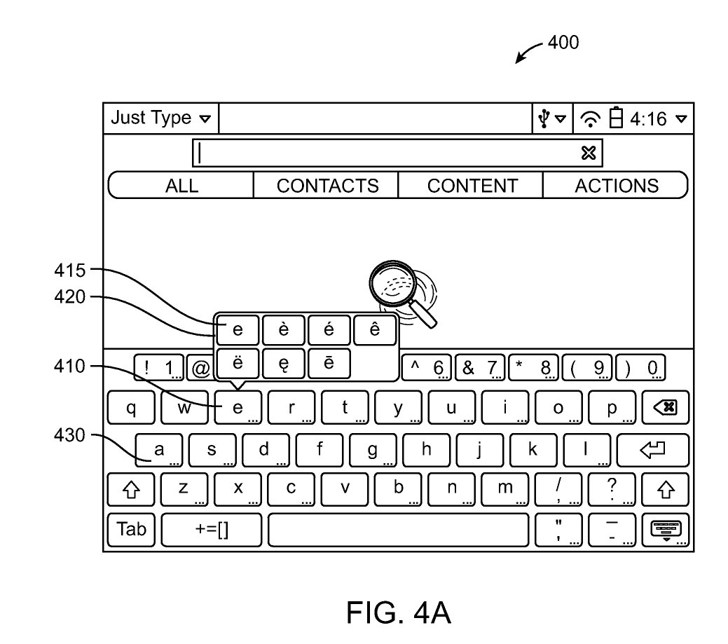

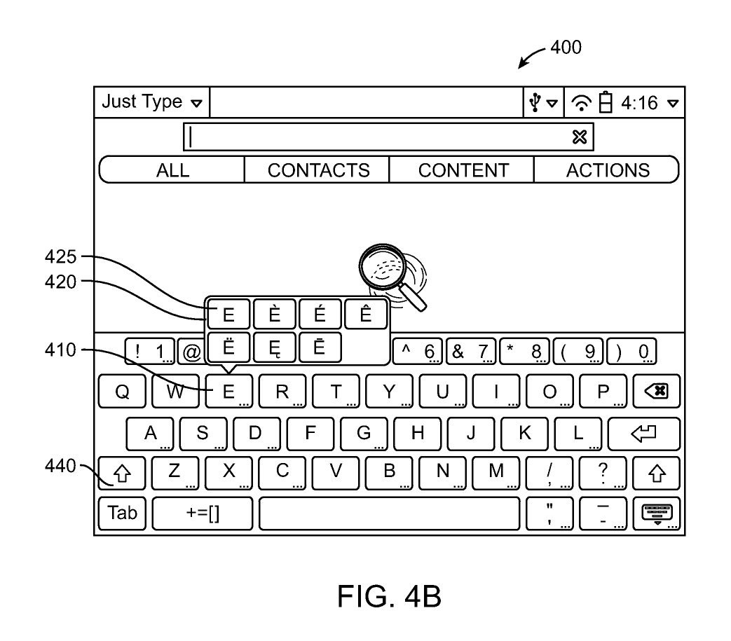

Referring to FIG. 4A, FIG. 4A illustrates a virtual keyboard 400 having a breakout box 420, in which additional virtual character keys 415 are displayed. In certain embodiments, one or more virtual character keys 410 may include markings 430, such as, for example, ellipses, to indicate that additional virtual character keys are available for that character. Although ellipses are specifically mentioned, it is contemplated that other markings or icons may be used.

As discussed above, the breakout box 420 is displayed in response to a user actuating a virtual character key 410 for a predetermined amount of time. Thus, when a user long-presses a virtual character key 410 containing markings 430, the breakout box 420 is displayed. However, if the user long-presses a virtual character key 410 without the markings 430, the character corresponding to the virtual character key 410 is output on the display.

As shown in FIG. 4A, the breakout box 420 may be located near or adjacent to the virtual character key 410 that was actuated for the predetermined amount of time. Although the breakout box 420 is shown adjacent to the virtual character key 410 which was actuated, it is contemplated that the breakout box 420 may be located on other areas of the display. Additionally, it is contemplated that the breakout box 420 and the additional virtual character keys 415 may be sized or resized along with, or separate from, the virtual keyboard 400 according to the method described above with respect to FIG. 2.

In certain embodiments, the breakout box 420 includes one or more additional virtual character keys 415. The additional virtual character keys 415 may include characters that have accent marks that correspond to the character of the actuated virtual character key 410. As discussed above, the virtual character key 410 may correspond to the English character “e”. Thus, when the virtual character key 410 is actuated for the predetermined amount of time, a breakout box 420 having additional character keys 415 with accented characters “\tilde{e}” “è” “ë” “ê” “é38 and “è” may be rendered on the display.

Referring back to FIG. 3B, once the additional characters are displayed in the breakout box 420 (FIG. 4A), actuation of a secondary key on the virtual keyboard is detected 380. In certain embodiments, the secondary key is a virtual “shift” key, virtual “caps lock” key or other alternative key that is present on the virtual keyboard 200. Upon detection of the actuation of the secondary key, capitalized versions of the additional virtual character keys 415 and the associated accented characters are rendered on the display 390.

The keypad may also be operated in an auto-cap mode, in which the first letter of each word is capitalized. In such situations, the capitalization of the additional characters will be done automatically, without “shift” or “caps lock” involved. The keyboard may be operated with logic that identifies the text that is entered at a current instance in a text field and the position of the cursor in that text field (e.g. word). The logic may be triggered by a secondary key, by context and/or by user input.

Referring to FIG. 4B, FIG. 4B illustrates a virtual keyboard 400 having a breakout box 420 with the additional virtual character keys 425 having capitalized accented characters. As discussed above, the additional virtual character keys 425 having the capitalized accented characters are displayed in the breakout box 420 in response to a user actuating a secondary character key 440, such as, for example a “shift” key or “caps lock” key. Although a “shift” and “caps lock” key are specifically mentioned, it is contemplated that additional keys or automatic logic (such as auto-cap described above) may be used to trigger the capitalization of the additional characters.

In certain embodiments, if the user has actuated the secondary character key 440 prior to long-pressing a virtual character key such that all of the virtual character keys are displayed as capitalized characters, and then the user long-presses one of the virtual character keys, the breakout box will display the additional characters as capitalized additional characters.

Once the capitalized additional characters have been rendered on the display, the user may actuate one or more of the additional virtual character keys and the corresponding accented additional character is output on the display.

In certain embodiments, if the user actuates a second virtual character key that is not a secondary key (e.g., a virtual “shift” key or virtual “caps lock” key) when the breakout box 420 is displayed, the character corresponding to the virtual character key that was actuated will be rendered on the display and the breakout box 420 is hidden. In another embodiment, the breakout box remains displayed until the user manually closes the breakout box 420 such as, for example, by clicking on an icon to indicate that the user is finished using the additional characters displayed in the breakout box or by actuating the virtual character key 410 for a predetermined amount of time. In another embodiment, a user may opt to replace the virtual character key with the selected additional virtual character key.

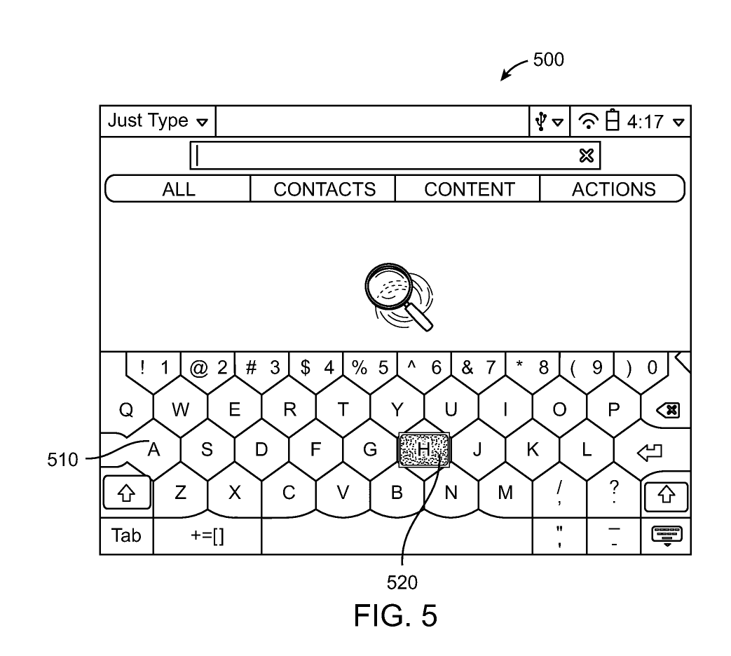

FIG. 5 illustrates a virtual keyboard 500 having a plurality of hit regions 510 that correspond to each of the virtual character keys 520. In certain embodiments, the hit regions 510 are scaled in size as the virtual keyboard 500 is sized or resized as described above with respect to FIGS. 2A-3A. Thus, as the size of each of the virtual character keys 520 increase and decrease in size, the corresponding hit region 510 of each of the plurality of virtual character keys also increase and decrease in size.

Although the virtual keyboard 500 shows the various hit regions 510 corresponding to each of the virtual character keys 520, it is also contemplated that the virtual keyboard 500 may be output on a display in the manner shown in FIG. 5 without an overlying graphic corresponding to the virtual character key 520. Thus, the virtual keyboard 500 may be displayed with hexagonal hit regions as the virtual character keys. In such embodiments, the virtual keyboard 500 may be sized or resized according to the methods described above with respect to FIGS. 2A-3A. Additionally, one or more additional virtual character keys may be output on the display according to the method set forth above with respect to FIG. 3B and illustrated by FIGS. 4A-4B.

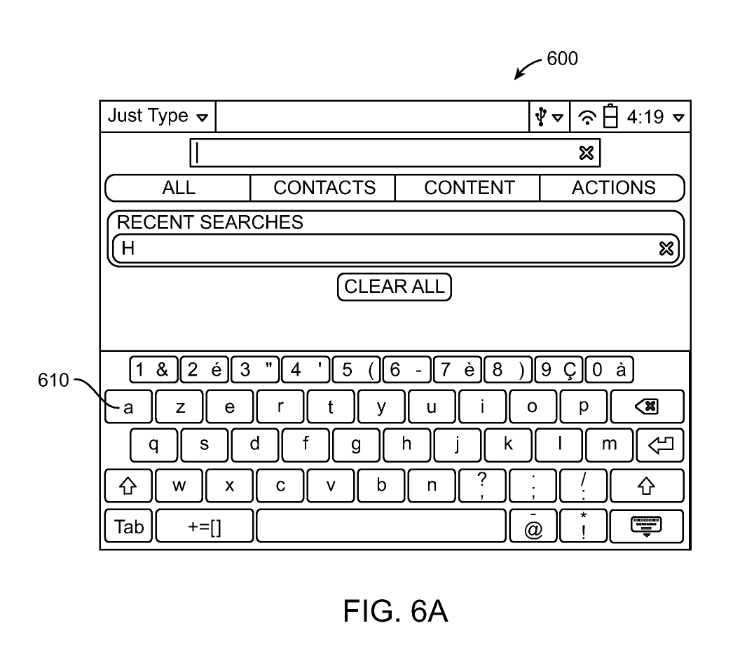

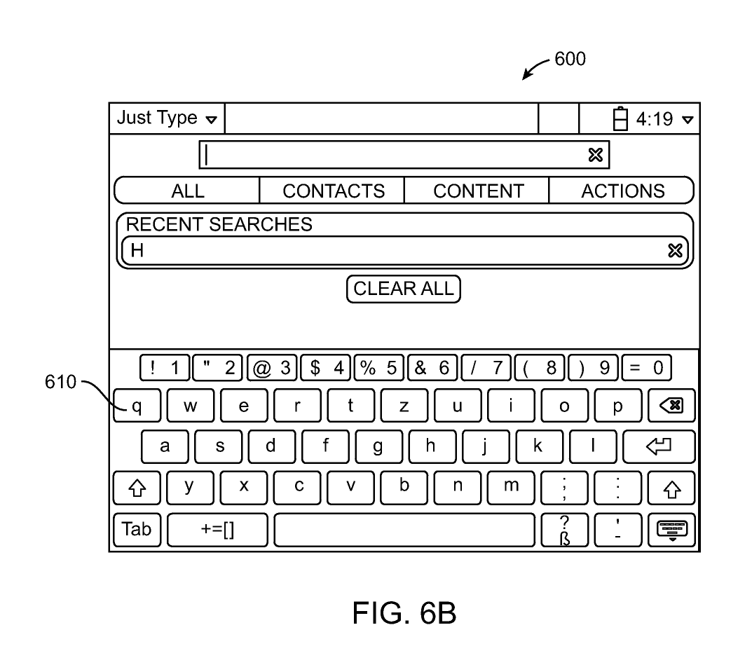

FIGS. 6A-6B illustrate virtual keyboards 600 having alternative arrangements of virtual character keys 610 according to one or more embodiments. For example, FIG. 6A illustrates an AZERTY keyboard configuration while FIG. 6B illustrates a QWERTZ keyboard configuration. As with the virtual keyboard 500 (FIG. 5), each of the virtual keyboards 600 shown in FIGS. 6A-6B may be sized or resized as described above with respect to FIGS. 2A-3A. Additionally, one or more additional character keys may be rendered on the display such as described above with respect to FIG. 3B.

FIG. 7 illustrates a hardware diagram for a computing device that is configured to support any of the embodiments described herein. An embodiment of FIG. 7 is depicted as a portable computing device 700. In particular, embodiments pertain to a slate or tablet device, which is a display dominant computing device. Tablets can have a monolithic form factor. The portable computing device includes roaming wireless network and/or cellular capabilities, including cellular telephony devices and/or portable messaging.

Other embodiments described herein may apply to numerous kinds of portable or small form-factor computing devices. One type of portable computing device that may be configured to include embodiments described herein includes a computer telephony device, such as a cellular phone or portable device with voice-telephony applications (sometimes called “smart phone”). A computing device such as described may provide functionality for messaging, web browsing, media playback, personal information management (e.g. such as contact records management, calendar applications, tasks lists), image or video/media capture and other functionality.

Specific types of messaging that may be performed include messaging for email applications, Short Message Service (SMS) messages, Multimedia Message Service (MMS) messages, and proprietary voice exchange applications (such as SKYPE). Still further, other types of computing devices contemplated with embodiments described herein include laptop or notebook computers, ultra-portable computers, personal digital assistants, and other multi-functional computing devices.

Still further, one or more embodiments may be implemented through any type of computing device such as a desktop computer that is configured to include real-time voice data exchange (e.g. through use of Internet Protocol telephony). Still further, other types of computer telephony devices exist, including standalone devices that connect directly to a telephone network (whether Internet Protocol or Public Switch Telephony System (PSTN)) and provide software interfaces and applications.

According to an embodiment, the device 700 may include one or more processors 710 (as processing resources), memory resources 720, one or more wireless communication ports 730, and various other input/output features, including a display assembly 740, a speaker 742, a microphone 744 and other input/output mechanisms 746. In certain embodiments, the one or more processors 710 are configured to receive input from the input/output mechanism 746. In certain embodiments, the input received from the input/output mechanism 746 may correspond to user input regarding the sizing of the virtual keyboard. Once the input is received by the processor 710, the processor 710 generates virtual keyboard output and transmits the output to the display 740. The processor also issues instructions to the display 740 which causes the display 740 to render the virtual keyboard according to the output. According to one or more embodiments, the display assembly 740 includes a touch-sensitive display interface to receive human contact (or close proximity) as input. More specifically, the display assembly 740 provides an interface by which interact with a virtual keyboard such as described by various embodiments herein.

### CONCLUSION

It is contemplated for embodiments described herein to extend to individual elements and concepts described herein, independently of other concepts, ideas or systems, as well as for embodiments to include combinations of elements recited anywhere in this application. Although illustrative embodiments have been described in detail herein with reference to the accompanying drawings, it is to be understood that the disclosure is not limited to those precise embodiments. As such, many modifications and variations will be apparent to practitioners skilled in this art. Accordingly, it is intended that the scope of the disclosure be defined by the following claims and their equivalents. Furthermore, it is contemplated that a particular feature described either individually or as part of an embodiment can be combined with other individually described features, or parts of other embodiments, even if the other features and embodiments make no mention of the particular feature. This, the absence of describing combinations should not preclude the inventor from claiming rights to such combinations.

What is claimed is:

1. A computing device comprising:
a memory that stores instructions for generating a virtual keyboard;
one or more processors configured to:
detect an input for a size of the virtual keyboard;
present the virtual keyboard at the desired size on a display surface.

2. The computing device of claim 1, further comprising a touch sensitive display screen on which the virtual keyboard is presented.

3. The computing device of claim 1, wherein the user input corresponds to a user selection of a size from a plurality of preset sizes.

4. The computing device of claim 1, wherein the one or more processors are configured to detect the input by detecting input corresponding to one of the preset sizes.

5. The computing device of claim 1, wherein the user input corresponds to a manual resizing of the virtual keyboard.

6. The computing device of claim 1, wherein the one or more processors are configured determine, from the detected input, a desired size for the virtual keyboard that is not preset.

7. The computing device of claim 6, wherein a first range of the manual resizing of the virtual keyboard corresponds to a first size of a plurality of predetermined sizes of the virtual keyboard and wherein a second range of the manual resizing of the virtual keyboard corresponds to a second size of the plurality of predetermined sizes of the virtual keyboard.

8. The computing device of claim 1, wherein the one or more processors are configured to determine the size of each of a plurality of virtual character keys that comprise the virtual keyboard, including scaling a size of a graphical region of each of the plurality of virtual character keys.

9. The computing device of claim 8, wherein the one or more processors are configured to determine the size of the graphical region of each of the plurality of virtual character keys by: (i) subtracting one or more pixels on each side of the graphical region of each of the plurality of virtual character keys, or (ii) adding one or more pixels on each side of the graphical region for each of the plurality of virtual character keys.

10. The computing device of claim 1, wherein the virtual keyboard is resizable when the computing device is in a portrait orientation and in a landscape orientation.

11. A method for resizing a virtual keyboard on a device having a display, the method comprising the steps of:
(a) receiving user input that indicates a desired size of the virtual keyboard;
(b) determining a size of the virtual keyboard; and
(c) presenting the virtual keyboard on the display to have the determined size.

12. The method of claim 11, wherein steps (a) through (c) are performed when the virtual keyboard is presented at a first size, so that presenting the virtual keyboard on the display to have the determined size includes changing the size of the virtual keyboard as presented.

13. The method of claim 12, wherein changing the size of the virtual keyboard includes changing a size of at least some of a plurality of virtual character keys that comprise the virtual keyboard.

14. The method of claim 12, wherein changing the size of the virtual keyboard includes changing a thickness of a region between individual virtual character keys that comprise the virtual keyboard.

15. The method of claim 11, wherein step (a) includes receiving a user selection of a size from a plurality of predetermined sizes of the virtual keyboard.

16. The method of claim 11, wherein the user input corresponds to a manual resizing of the virtual keyboard.

17. The method of claim 11, wherein receiving user input corresponding to a desired size of the virtual keyboard includes receiving user input when the virtual keyboard is displayed on the device when the device is in either of a portrait orientation or a landscape orientation.

18. The method of claim 11, further comprising automatically scaling the rendered virtual keyboard from a first size to a second size when the device is moved from a first orientation to a second orientation.

19. The method of claim 11, wherein determining a size of each of the plurality of virtual character keys includes scaling a size of a graphical region of each of the plurality of virtual character keys.

20. The method of claim 19, wherein scaling the size of the graphical region of each of the plurality of virtual character keys includes one of: (i) subtracting one or more pixels on each side of the graphical region of each of the plurality of virtual character keys, or (ii) adding one or more pixels on each side of the graphical region for each of the plurality of virtual character keys.

21. The method of claim 11, wherein at least one of the plurality virtual character keys includes a graphical indicator to indicate that one or more special characters corresponding to the at least one of the plurality of virtual character keys are available.

22. The method of claim 21, further comprising detecting user actuation of the at least one of the plurality of virtual character keys having the graphical indicator for a predetermined amount of time.

23. The method of claim 11, further comprising associating with one or more virtual character keys of the virtual keyboard, a set of alternative characters, and then responsive to user selection to display the alternative set, displaying the one or more special characters.

24. The method of claim 23, further comprising displaying the one or more special characters concurrently in a panel that is presented adjacent or overlaid with respect to the virtual keyboard.
